(19) United States
(12) Patent Application Publication
(10) Pub. No.: US 2005/0121815 A1
(43) Pub. Date: Jun. 9, 2005

(54) Method for blending and fabricating personalized lipstick

(75) Inventor: Mary Swaab, Rockford, IL (US)

Correspondence Address: LEYDIG VOIT & MAYER, LTD, 6815 WEAVER ROAD, SUITE 300, ROCKFORD, IL, 61114-8018, US

(73) Assignee: Graf Enterprises, LLC, Rockford, IL (US)

(21) Appl. No.: 11/036,831

(22) Filed: Jan. 14, 2005

Related U.S. Application Data
(63) Continuation of application No. 09/714,318, filed on Nov. 16, 2000.
Application No. 09/714,318 is a continuation-in-part of application No. 09/363,129, filed on Jul. 28, 1999, now Pat. No. 6,402,120.
Application No. 09/363,129 is a continuation-in-part of application No. 08/924,196, filed on Sep. 5, 1997, now Pat. No. 5,971,351.

(51) Int. Cl. B29B 7/00; B29C 41/22

(52) U.S. Cl. 264/40.1; 264/78; 264/349

(57) ABSTRACT

An apparatus and method for custom blending and fabricating lipstick to the specific demands of individual customers. The present invention provides a kit which enables a user to blend various pigments to arrive at a very specific shade, and then blend the desired shade with a specific base to result in a desired consistency of lipstick, and which also allows the blended bases and pigments to be heated to a liquefied form and poured into a mold for hardening. Upon cooling and hardening, a conventional lipstick case can be attached to the lipstick for removal from the mold and use by the customer. The present invention therefore not only allows a user to quickly attain the specific shade and consistency of lipstick desired, but also eliminates the time consuming and unsatisfactory process of visiting multiple stores having expansive inventories of variously shaded and textured lipsticks.

### CROSS-REFERENCE TO RELATED PATENT APPLICATIONS

This patent application is a continuation of copending U.S. patent application Ser. No. 09/714,318, filed Nov. 16, 2000, pending, which is a continuation-in-part of copending U.S. patent application Ser. No. 09/363,129, filed Jul. 28, 1999, now U.S. Pat. No. 6,402,120, issued Jun. 11, 2002, which is a continuation-in-part of copending U.S. patent application Ser. No. 08/924,196, filed Sep. 5, 1997, now U.S. Pat. No. 5,971,351, issued Oct. 26, 1999.

### FIELD OF THE INVENTION

The present invention generally relates to cosmetics, and more particularly relates to apparatus and methods for creating lipsticks.

### BACKGROUND OF THE INVENTION

When a person is desirous of purchasing cosmetics, he or she is often confronted with a time consuming and very often unsatisfactory process. Retail outlets often carry only a limited number of manufacturers and their product lines, and if a customer cannot find the particular shade or consistency of lipstick desired, he or she will be required to visit additional retail outlets in search of another manufacturer and its product line which may or may not provide the particular shade or consistency of lipstick desired. Even after finding an acceptable lipstick, it is often shortlived in that the manufacturer may discontinue production of the desired type.

Alternatively, the customer can resort to catalogs or other written material which will provide the customer with an expansive list of information and possibly the particular shade and consistency of lipstick desired. However, the shade as it appears in printed form on the advertisement may be quite different from the shade when worn and viewed in ambient lighting conditions as opposed to the printed conditions of the catalog.

Such a system is not only frustrating and unsatisfactory to the client, but can also be unsatisfactory to the retailer and manufacturer. The retailer is required to maintain an expansive line of lipstick in inventory which may or may not turn over in profitable fashion, which necessarily limits the retailer to carrying only the best selling lines, or most cost-effective lines. The retailer will therefore not be able to fully satisfy all the needs of his or her client base. From the manufacturer standpoint, such a system is unsatisfactory in the sense that its product lines will be only carried in a few retail outlets which necessarily limits the total client base to which the manufacturer can extend its goods.

Certain areas of the cosmetics industry have therefore recognized this deficiency in the current system and devised alternatives to more closely tailor cosmetic products to the specific desires of the given customer. For example, U.S. Pat. No. 5,031,764, issued to Meador, et al, discloses an apparatus for designing personalized perfume by providing a system of tapered strips along with a family of fragrances. An individual is therefore able to use the apparatus of Meador '764 to design customized perfume or cologne in relatively quick fashion.

However, while systems such as the Meador '764 patent do provide a system by which personalized perfumes and colognes can be created, no system currently exists to create personalized or specially tailored cosmetics corresponding to the exact demands of each customer, and more specifically to the focus of the present invention, no system or method currently exists to allow specific shades, consistencies and textures of lipsticks to be created based on the specific demands of each customer. It therefore follows that no system currently exists to allow for customized lipstick creation in a relatively short time frame, without relying on a system of ordering and waiting for delivery from an off-site warehouse.

### BRIEF SUMMARY OF THE INVENTION

It is therefore a primary aim of the present invention to provide an apparatus and method for custom blending lipstick to a desired shade, consistency and content, and fabricating the blended lipstick while the customer waits.

It is an objective of the present invention to provide a kit for use by cosmetic retailers which can be used to custom blend a particular shade and consistency of lipstick to the exact and immediate demands of the customers, and with which a conventional retractable lipstick case can be fabricated with the custom blended lipstick therein while the customer waits.

It is another objective of the present invention to provide a kit for personal use which can be used to custom blend lipstick at home or various other locations away from retail establishments.

It is another objective of the present invention to provide a kit which not only allows the specific color of the lipstick to be blended, but which also allows various additives, such as moisturizers, sunscreens, fragrances, and frostings, to be added to the resulting lipstick.

It is another objective of the present invention to provide a kit for creating custom blended lipstick which provides a means by which the exact portions of the various colored pigments, bases, and additives can be measured and recorded to allow for additional batches of lipstick to be created after a specific combination and recipe has been established.

It is still another objective of the present invention to provide a kit which allows the custom blended lipstick to be blended and manufactured in a matter of minutes.

It is still another objective of the present invention to provide a kit and method which allows for custom blending and fabrication of lipstick in a consistent and repeatable manner.

In accordance with these and other objectives, the present invention is directed at a method of fabricating custom blended lipstick using a kit either at a retail establishment or at home. The kit includes pigments, at least one base (preferably several bases) and a mold. The pigments and bases are mixed together to get the desired blend to meet the demands of the individual person. The mixed pigments are heated then cooled in the mold.

A further improvement disclosed in this CIP application is a two step process for achieving the desired shade of lipstick. According to this improvement, pigments are first mixed (preferably on a blending sheet) and the base material is softened via heat and then mixed together to get a pigment-base mixture. It has been found that the base (even if neutral in color) or the lips of the person can effect the appearance. As such, the pigment-base mixture is then applied to the lips of the person for evaluation to ensure that the mixture meets that person's desire. If the person is happy with the mixture, the mixture is then heated and then cooled in the mold to form the lipstick or other lip coloring product. If not, then further pigments or bases can be added to adjust the pigment-base mixture to achieve the desired shade and texture. After the addition of more pigment or base (and further application and evaluation if desired) then the adjusted mixture is then heated and then cooled in the mold.

Other aspects, objectives and advantages of the invention will become more apparent from the following detailed description when taken in conjunction with the accompanying drawings.

### BRIEF DESCRIPTION OF THE DRAWINGS

FIG. 1 is a perspective view of the preferred embodiment of the present invention;

FIG. 2 is a plan view of the measuring sheet and the blending sheet used in conjunction with the preferred embodiment of the present invention;

FIG. 3 is a perspective view of the mold used in conjunction with the preferred embodiment of the present invention;

FIG. 4 is a sectional view of the mold shown in FIG. 3 taken along line 4-4;

FIG. 5 is a sectional view of the mold taken along line 5-5 of FIG. 3; and

FIG. 6 is a perspective view of the mold after the lipstick blend has been poured and hardened, and after the top layer of the mold has been removed to facilitate attachment of lipstick holding cases to the lipstick.

While the present invention is susceptible of various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions and equivalents falling within the spirit and scope of the invention as defined by the appended claims.

### DETAILED DESCRIPTION OF THE INVENTION

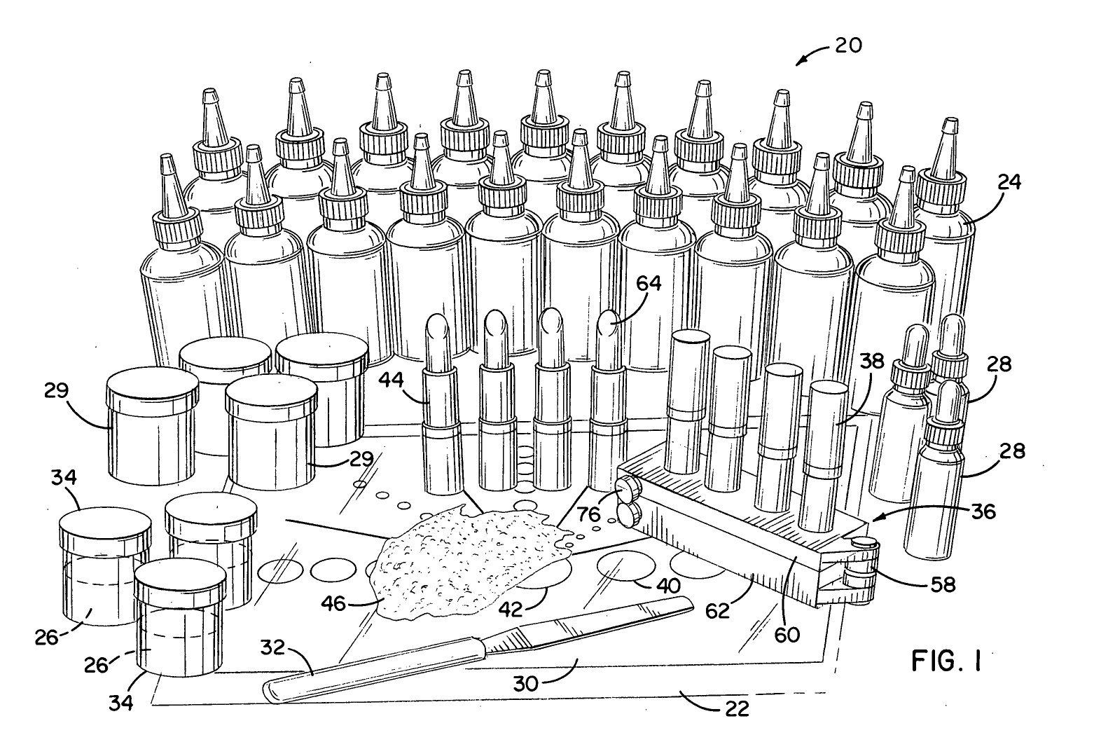

Referring now to the drawings, and with specific reference to a FIG. 1, the preferred embodiment is shown and is generally designated as kit 20. As shown therein, kit 20 includes graduated measuring sheet 22, pigments 24, bases 26, additives 28, frostings 29, blending sheets 30, mixing tool 32, heating vessel 34, mold 36 and lipstick cases 38. It is to be understood that the actual number of pigments 24, bases 26, additives 28, frostings 29, blending sheets 30, and lipstick cases 38 provided with each kit 20 can certainly vary, but that the stated elements are all included in the preferred embodiment of the present invention. It is also to be understood that in alternative embodiments, additional additives can be included with kit 20 to further enhance the variability of the lipstick. As indicated in the drawings, the kit 20 is typically packaged together in a sellable package which may be used in either a retail store or a home. The size and variety of the containers of pigments and bases can be adapted to meet the particular consumer needs.

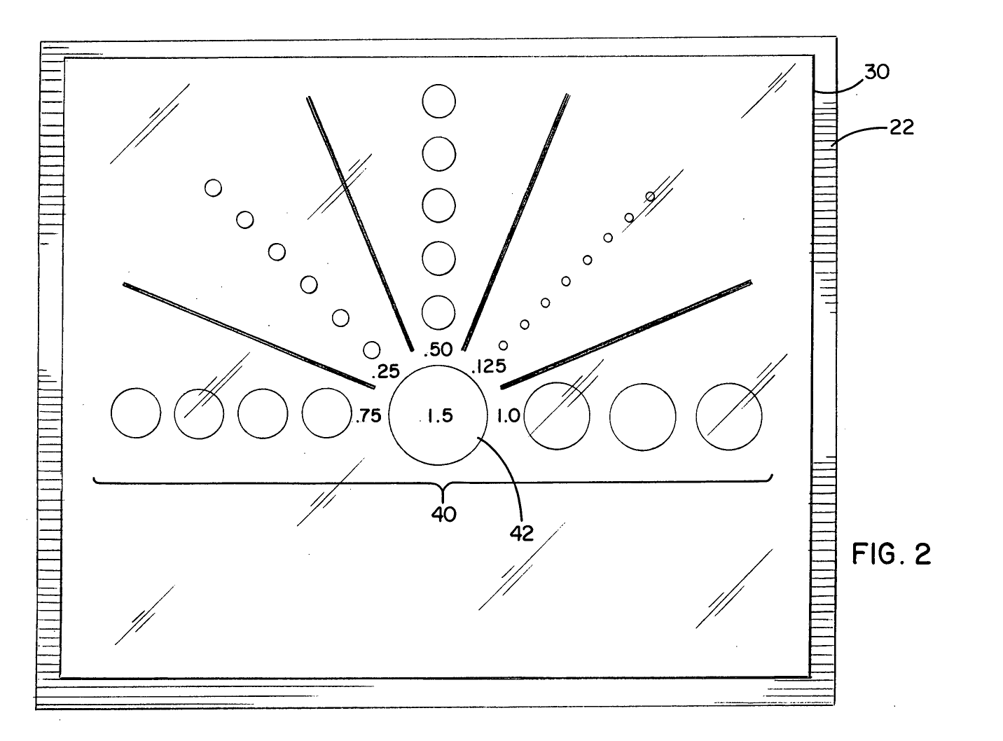

With specific reference now to measuring sheet 22, FIG. 2 shows that measuring sheet 22 is a planar sheet which in the preferred embodiment is preferably manufactured from acrylic, but which could alternatively be made of a relatively heavy grade of paper or possibly a light grade of cardboard. In alternative embodiments, different means for measuring can be provided which need not take the specific form of that shown in FIG. 2. However, as shown in FIG. 2, measuring sheet 22 also includes a plurality of graduated segments 40 into which pigments 24 can be poured. In the preferred embodiment, one graduated segment 40 having a nominal denotation of 1.5 is provided in a central position with sets of graduated segments ranging from nominal denotations of 0.125 to 1.0 shown radiating out from central segment 42. In alternative embodiments, segments 40 need not be provided in the specific dimensions shown in FIG. 2, but rather can be provided in any size providing a means by which the components can be consistently measured into pre-determined quantities of pigments 24. Other appropriate measuring means may include scoops, spoons, scales, droppers, measuring cups, metering devices, and other similar measuring devices.

In order to reduce the overall cost of kit 20, only one measuring sheet 22 is provided with each kit, but through the novel use of translucent blending sheets 30, measuring sheet 22 can be used in repetition. In other words, blending sheet 30 can be placed over a measuring sheet 22 such that graduated segments 40 are visible through translucent blending sheet 30. While blending sheet 30 is depicted in the drawings as being smaller than measuring sheet 22, such depiction is only for the purposes of clearer illustration, in that blending sheet 30 is actually the same size as measuring sheet 22 in the preferred embodiment. The retailer can pour pigments 24 directly onto translucent blending sheet 30 using the graduated segments 40 of measuring sheet 22 as a guide. The measured quantity of pigment 24 can then be moved to a separate and distinct area of blending sheet 30 for subsequent combination with additional pigments 24. For example, one pigment 24 having a particular red hue can be measured using one of the graduated segments 40 and if it is desired to create a resulting lipstick 44 having a relatively orange appearance, a pigment having a yellow hue can be measured and added. This process can be repeated using the various shades of pigments 24 provided with kit 20 until the specific shade desired by the customer is achieved.

While the list of particular pigments 24 provided with each kit 20 can vary greatly with each kit 20 sold, in the preferred embodiment twenty distinct pigments are provided, each in its own respective container as indicated in the drawings. The exact chemical compound used to create each pigment 24 is not of importance to the present invention, but rather the shades, or family of shades, is of importance to the present invention. Toward that end, four distinct family of shades are provided, namely: cool shades, i.e., blackberry, wineberry, ruby red, and magenta; warm shades, i.e., coral, crimson, paprika, flame, tangerine, peach, and russet; brown shades, i.e., brown, mahogany, and cocoa; and toner shades, i.e., white, black, ochre, marigold, sapphire, and blueberry. It is to be understood that through the provision of such a wide variety of pigments 24 a resulting family of lipstick shades numbering in the thousands can be achieved.

In addition to pigments 24, a variety of bases 26 are also provided, each base 26 being contained in its own individual container as illustrated in the drawings. In the preferred embodiment, the bases include a cream base used to create a relatively moist, sheer, or frosted lipstick, a matte base used to create a long lasting lipstick, and a butter base, used to create an extremely sheer and glossy lipstick. Again, the exact chemical composition of the bases 26 are not of particular relevance to the present invention, but rather it is to be understood that bases 26 are used primarily to create the texture and consistency of the resulting lipstick 44, whereas pigments 24 are used to create the specific color of lipstick 44. While bases 26 of the preferred embodiment are not shaded, alternative embodiments could include a larger number of bases already pre-colored to a particular hue. The pre-colored bases could then provide a starting point to which colored pigments could be added.

With regard to additives 28 and frostings 29, the preferred embodiment of the present invention includes a variety of additives which can be added to the blended pigments 24 and bases 26 to alter the characteristics of lipstick 44. For example, a moisture additive including known moisturizers such as oils and vitamins can be provided, a sunscreen additive having a specific sun protection factor (SPF) can be added, or a frost additive used to create a specific texture or reflective appearance can also be added. A frost additive is considered to be a pigment as understood by those skilled in the art and is often in powdered form and measured by scoops. For lip coloring products such as lip gloss, frosts may be the only type of pigment in the kit. Moreover, if it is desired to have a particular fragrance or flavor in accompaniment to the specific shade of lipstick 44, various scents or flavors can be added as well. Such additives 28 and frostings 29, would be added to pigments 24 and bases 26 in the same manner as mentioned above or according to the preferred method herein described. Any variety of tools can be used to dispense the additives including scoops, brushes, and droppers.

Upon arriving at the particular shade, of the desired lipstick 44, the resulting blend 46, in the preferred method, can be deposited into heating vessel 34 already containing base 26 for subsequent heating and liquefaction. Bases 26 are preferably provided in heating vessel 34 in sufficient quantity to form two (2) lipsticks, however, it is to be understood that different quantities can be provided. It is also to be understood that bases 26 can be mixed with blend 46 on blending sheet 30 if desired and then deposited into heating vessel 34 for liquefaction. To perform this function, mixing tool 32 or an alternative tool can be used to scrape blend 46 from the blending sheet 30 and into heating vessel 34. Blending sheet 30 can then be removed and thrown away to leave measuring sheet 22 ready for subsequent uses.

In normal operation, the specific quantities of pigments 24, bases 26, additives 28 and frostings 29 would be recorded using a recordation sheet to memorialize the specific composition of blend 46. In order to transform blend 46 into the shape of a conventional lipstick 44, heating vessel 34 is heated to a temperature sufficient to liquefy blend 46 and base 26. In the preferred embodiment, this is performed through the use of a conventional microwave oven preferably having a maximum power output of 600-650 watts. Under normal circumstances using such an oven a heating time of approximately sixty seconds will be sufficient to adequately liquefy the composition. Other suitable heating means that can also be used with the kit of the present invention include a heating block, a steam bath, a water bath, a conventional oven, a flame, a hot air blower, any number of electrical heating devices (such as a hot light), or other such heating mechanisms known in the art. In any event, it is understood that the heating means is typically not sold with the kit but is a device that the buyer of the kit typically already has at their home or store.

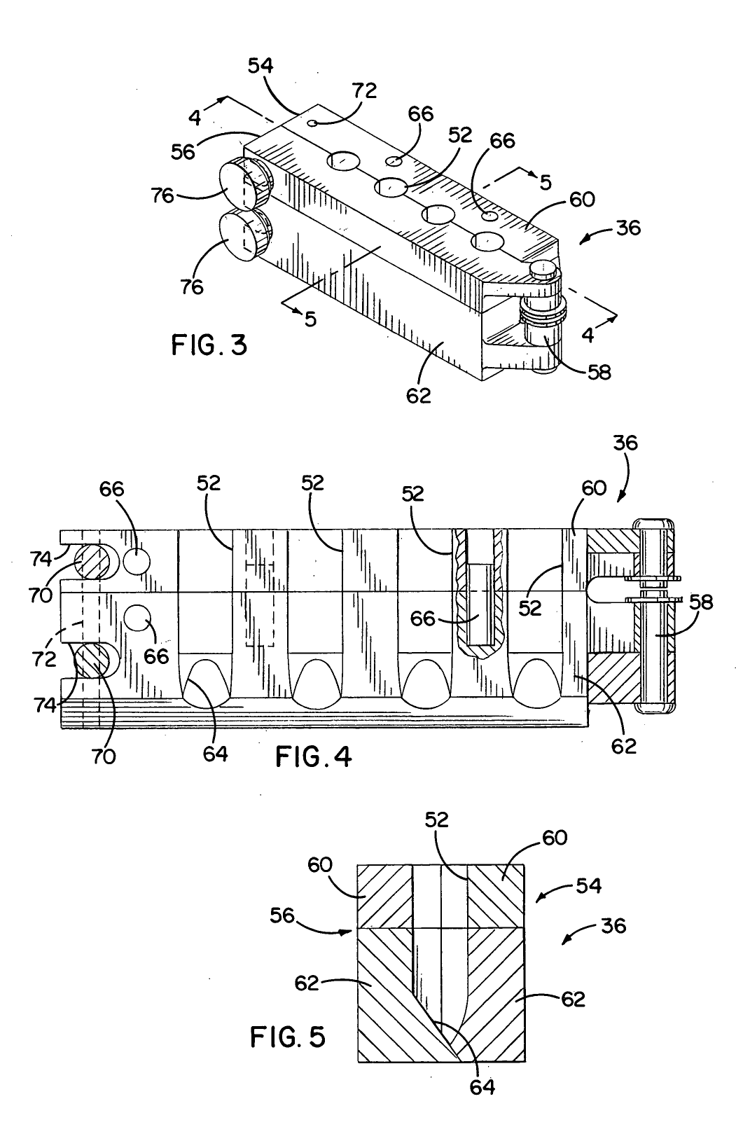

After blend 46 and base 26 have been heated to the point of liquefaction, the liquefied blend can be poured from heating vessel 34 into mold 36. Alternatively, additional pigments, additives, or frostings can be added after heating to further fine tune the lipstick. More specifically, the liquefied blend 46 can be poured from heating vessel 34 into one of the cavities 52 provided in mold 36. In the preferred embodiment, four cavities 52 are provided, but it is to be understood that in alternative embodiments, the exact number of cavities 52 can vary greatly. As shown in FIGS. 3 and 4, the preferred embodiment of mold 36 is of a clam shell design having first and second mating sides 54 and 56. Sides 54 and 56 are joined by hinge 58 to allow for removal of lipsticks 44. It can also be seen that each side 54 and 56 is comprised of a top portion 60 and bottom portion 62, the importance and function of which will be described in further detail herein. Although only the preferred form of mold 36 is depicted, it is to be understood that a wide range of mold types can be employed including metal molds, plastic molds, single cavity molds, multiple cavity molds, and the like. Such molds need not be in the shape of a conventional lipstick, but can be of the shape of a lip balm jar, tub or the like. Products stored in a lip balm jar which are equivalent to lipstick include lip gloss which is somewhat softer that lipstick in composition and can be applied with a tool or alternatively with a finger. Lipstick, lip gloss and the like can generally be characterized as lip coloring products.

With regard to each bottom portion 62 of first and second sides 54 and 56, it can be seen that when brought together in mating orientation, they form cavities 52 having the shape of a conventional lipstick with canted tip 64 (See FIG. 5). It can also be seen that the diameter of cavities 52, as well as the depth of cavities 52 will result in a lipstick 44 having a conventional shape and size. In order to correctly and consistently align first and second side 54 and 56 as well as top and bottom portions 60 and 62, dowels 66 are provided to penetrate through adjacent portions to thereby align adjacent portions and result in uniformly shaped cavities 52. In order to further lock first and second sides 54 and 56 into mating configuration, locking clasps are used to join first side 54 to second side 56 when desired. As best shown in FIG. 4, each locking clasp is comprised of threaded rod 70 which is adapted to pivot about pin 72 attached to first side 54 and pass through channel 74 provided in second side 56. Threaded knob 76 can then be used to attach to rod 70 and be tightened against the outer surface of second side 56 to lock first side 54 and second side 56. Similar locking clasps are provided for top portion 60 and bottom portion 62.

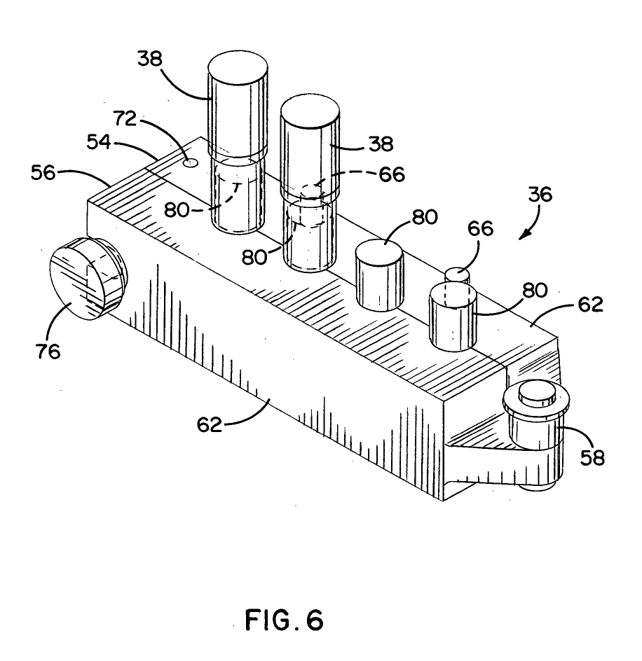

When it is desired to pour heated blend 46 from vessel 34 into mold 36, first and second sides 54 and 56 will be joined together as will top portions 60 and bottom portions 62 as best shown in FIG. 3. Heated blend 46 will be poured into cavities 52 until full and allowed to cool. In the preferred embodiment, approximately three minutes will be required to allow the heated blend 46 to cool to a hardened state at which time top portion 60 of first side 54 can be loosened from top portion 60 of second side 56. Top portion 60 can then be entirely removed from mold 36 to reveal bottoms 80 of lipsticks 44 as best shown in FIG. 6. At this point, lipstick cases 38, which are of a conventional design, can be pressed down onto bottoms 80 and, given the consistency and texture of lipstick 44, adhered thereto. To facilitate this action, it is desirable that lipstick case 38 be rotated to its uppermost extended position to allow for its base to easily contact bottom 80 of lipstick 44. Alternatively, the hardened lipstick 44 can be re-melted and additional pigments or additives can be added before affixing the lipstick cases 38.

As shown in FIG. 6, upon lipstick case 38 being adhered to lipstick 44, the individual lipsticks 44 can be removed from cavities 52 of bottom portion 62. Case 38 can then be rotated to retract lipstick 44 into case 38 to allow for a cap to be attached thereto. In the preferred embodiment, a non-stick coating is provided on each cavity 52 to facilitate removal of lipsticks 44 from mold 36. In the most preferred embodiment, a non-stick coating similar to Teflon® is used, but other non-stick compounds having similar characteristics can be used with equal efficacy.

From the foregoing, it can therefore be seen that the present invention brings to the art a new and improved apparatus and method by which lipstick can be custom blended, at a retail counter, or at home for personal use, and fabricated into a conventional lipstick case for use in a matter of minutes. Such a kit not only greatly expands the ability of a retail outlet to tailor its supply to the specific demands of the individual customer, but greatly enhances the satisfaction of the individual customer by quickly providing the exact shade and consistency of lipstick desired without the time consuming and often futile process of visiting multiple retailers and searching through expansive volumes of lipstick inventory. Moreover, once a particular lipstick is created, its recipe can be recorded for subsequent batch creation to thereby avoid reliance on a particular manufacturer which subsequently discontinues a desired type of lipstick.

It will also be appreciated that in another embodiment, one or each of the containers used for the bases may double as a heating vessel for use in heating the lip coloring product to a liquefied form. The mold itself could also be utilized as a heating vessel if so desired. Regular household items could also be selected for use as a heating vessel.

A new method is also disclosed in this application, namely a two step process for achieving the desired shade of lipstick. According to this further improvement, pigments are first mixed (preferably on a blending sheet) and the base material is softened via heat and then mixed together to get a pigment-base mixture. The softening step does not necessarily liquefy the base but heats it sufficiently so that it may be easily applied to the person's lips for evaluation. It has been found that the base (even if neutral in color) or the lips of the person can effect the appearance. As such, the pigment-base mixture is then applied to the lips of the person for evaluation to ensure that the mixture meets that person's desire. If the person is happy with the mixture, the mixture is then heated and then cooled in the mold to form the lipstick or other lip coloring product. If not, then further pigments or bases can be added to adjust the pigment-base mixture to achieve the desired shade and texture. After the addition of more pigment or base (and further application and evaluation if desired) then the adjusted mixture is then heated into liquefied form and then cooled in the mold. These steps are preferably conducted at the retail establishment while the retail customer waits and is available for the application and evaluation step. The retail customer thus becomes integrally involved in formulating and making her own lipstick or lip coloring product.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for custom blending and fabricating a lipstick at a retail establishment to personal specifications of a person, the method comprising:
receiving a customer demand from the person for a custom blended lipstick at the retail establishment;
mixing selected quantities of a plurality of selected pigments in accordance with the customer demand to arrive at a pigment mixture;
softening at least one lipstick base via heat such that the lipstick base is suitable for mixing with pigments;
mixing the pigment mixture with the at least one lipstick base to arrive at a base-pigment mixture; thereafter
applying the base-pigment mixture to lips of the person for evaluation; thereafter heating the base-pigment mixture; and
cooling the base pigment mixture in a mold.

2. The method of claim 1 further comprising the step of
adding at least one pigment during a step after the applying step and before the heating step to adjust the base-pigment mixture.

3. The method of claim 1 further comprising the step of
adding at least one base during a step after the applying step and before the heating step to adjust the base-pigment mixture.

4. The method of claim 1 wherein said mold is a lipstick mold in which the base-pigment mixture is cooled in the lipstick mold to form a lipstick, further comprising:
removing the lipstick from the lipstick mold; and
affixing the lipstick to a lipstick case.

5. The method of claim 1 wherein the two steps of mixing are conducted on a blending sheet.

6. The method of claim 1 wherein the steps of the method are conducted while the person waits at the retail establishment.

7. A method for custom blending and fabricating lip coloring product to personal specifications of a person of using a kit at a retail establishment, the kit including a mold, a plurality of pigments in bulk form that are free of pre-measured individual units and at least one base, the method comprising the steps of:
receiving a customer demand from the person for a custom blended lip coloring product at the retail establishment;
heating the at least one base;
selecting various pigments from the plurality of differently shaded pigments based upon the customer demand;
measuring quantities of selected pigments from said bulk form that are free of pre-measured individual units with a measuring device;
mixing measured quantities of the pigments with the at least one base; and
cooling the mixed at least one base and pigments in a mold.

8. The method of claim 7 wherein the mixing step comprises:
mixing selected quantities of a plurality of measured pigments in accordance with the customer demand to arrive at a pigment mixture;
softening at least one lipstick base via heat such that the lipstick base is suitable for mixing with measured pigments; and thereafter
mixing the pigment mixture with the softened at least one lipstick base to arrive at a base-pigment mixture.

9. The method of claim 8 further comprising the step of
adding and mixing at least one pigment during a step after said mixing step and before the heating step to adjust the base-pigment mixture.

10. The method of claim 7 wherein said kit further includes a blending sheet, wherein said mixing step is conducted on the blending sheet.

11. The method of claim 7 wherein the measuring step is performed with at least one measuring device selected from the group consisting of a graduated blending sheet, a scoop, a spoon, a dropper, a measuring cup, and a metering device.

12. The method of claim 7 wherein said mold is a lipstick mold in which the base-pigment mixture is cooled in the lipstick mold to form a lipstick, further comprising:
removing the lipstick from the lipstick mold; and
affixing the lipstick to a lipstick case.

13. The method of claim 7 wherein the steps of the method are conducted while the person waits at the retail establishment.

14. A method for custom blending and fabricating lipstick at a retail establishment to personal specifications, the method comprising:
receiving a demand from an individual person for a custom blended lipstick at the retail establishment;
selecting various pigments from a plurality of differently shaded pigments in bulk form that are free of pre-measured individual units;
measuring quantities of the selected pigments from said bulk form that are free of pre-measured individual units with a measuring device in accordance with the demand of the individual person;
selecting at least one base from a plurality of lipstick bases offering a variety of textures and consistencies in accordance with the demand of the individual person;
mixing the measured quantities of lipstick pigments with the at least one selected base;
heating the at least base into mixable form; and
pouring the mixed pigments and at least one base into a mold.

15. The method of claim 14 further comprising cooling the lipstick in the mold, and affixing the cooled lipstick to a lipstick case.

16. The method of claim 15 wherein the steps of measuring, selecting, adding, heating, pouring, cooling, and affixing are all done at the retail establishment.

17. The method of claim 16 further comprising repeating the selecting measuring and mixing steps until the desired shade of the individual person is accomplished according to the demand.

18. The method of claim 14 further comprising evaluating the color of the mixture of the pigments and the at least one base, and adjusting the color of the mixture of the at least one base and the pigments by adding an additional quantity of a selected pigment with the at least one base after said heating.

19. The method of claim 7 further comprising selecting various bases from a plurality of bases to provide a desired texture and consistency for the lip coloring product, mixing the selected bases with the measured quantities of selected pigments.

20. The method of claim 7 further comprising premixing the measured quantities of pigments to arrive at a desired shade and color for the lip coloring product, said premixing being conducted prior to said mixing.

21. The method of claim 20 further comprising adding the premixed measured quantities of pigments to said at least one base prior to said heating.

22. The method of claim 7 wherein said measuring is conducted with a graduated blending sheet having a plurality of graduated segments of known quantity.

23. The method of claim 14 wherein said measuring is conducted with a graduated blending sheet having a plurality of graduated segments of known quantity.

24. The method of claim 1 wherein the method is accomplished without counting pellets.

25. The method of claim 7 wherein the method is accomplished without counting pellets.

26. The method of claim 14 wherein the method is accomplished without counting pellets.

27. The method of claim 1 wherein at least one of the plurality of pigments is contained in a container having a dispensing nozzle.

28. The method of claim 7 wherein at least one of the plurality of differently shaded pigments is contained in a container having a dispensing nozzle.

29. The method of claim 14 wherein at least one of the pigments is contained in a container having a dispensing nozzle.

30. The method of claim 1 wherein said mixing is conducted without and free of a mortar.

31. The method of claim 7 wherein said mixing is conducted without and free of a mortar.

32. The method of claim 21 wherein said mixing is conducted without and free of a mortar.
